(19) United States
(12) Patent Application Publication
(10) Pub. No.: US 2010/0321882 A1
(43) Pub. Date: Dec. 23, 2010

(54) Computing Device Locking Mechanisms

(76) Inventors: Mark S. Tracy, Tomball, TX (US); Dustin L. Hoffman, Cypress, TX (US); Paul J. Doczy, Cypress, TX (US); Jeffrey A. Lev, Tomball, TX (US); Earl W. Moore, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/866,491

(22) PCT Filed: Mar. 31, 2008
(86) PCT No.: PCT/US08/58836

§ 371 Date: Aug. 6, 2010

(51) Int. Cl. G06F 1/16; E05C 3/14

(52) U.S. Cl. 361/679.55; 292/195; 292/220

(57) ABSTRACT

A locking mechanism includes a release button, a pivot shaft on which the release button is provided, a locking element fixedly mounted on the pivot shaft, and a stop member that is aligned with the locking element when the locking mechanism is in a locked position, wherein contact between the locking element and the stop member prevents pivoting of the locking element and the pivot shaft but depression of the release button moves the locking element clear of the stop member to enable pivoting of the pivot shaft.

### BACKGROUND

Most notebook computers comprise latch mechanisms that lock the computer in the closed position in which the display portion of the computer is positioned in contact with or directly adjacent to the base portion of the computer. To open the computer, the latch mechanism must be released, typically by sliding a latch to the left or right, and then manually lifting the display portion.

Although such a locking/opening scheme works adequately well, it is not particularly exciting or even interesting to most computer users. Accordingly, alternatives are desired.

### BRIEF DESCRIPTION OF THE DRAWINGS

The disclosed locking mechanisms can be better understood with reference to the following drawings. The components in the drawings are not necessarily to scale.

FIG. 1 is a partial left side perspective view of an embodiment of a computing device, illustrating an internal spring of the computing device.

FIG. 2 is a partial right side perspective view of the computing device of FIG. 1, illustrating a locking mechanism of the computing device.

FIG. 3 is a front perspective view of an embodiment of the locking mechanism shown in FIG. 2.

FIG. 4 is a rear perspective view of the locking mechanism of FIG. 3.

FIGS. 5A-5D are front views of the locking mechanism of FIGS. 2 and 3 that illustrate the locking mechanism positioned in various orientations, each orientation pertaining to a given display portion orientation.

### DETAILED DESCRIPTION

Disclosed herein are computing device locking mechanisms. In some embodiments, the locking mechanisms include a release button that is integrated with a hinge that pivotally connects a display portion of the computing device to a base portion of the computing device When the display portion is locked in a closed position, the button is in an extended position. When the button is pressed by a user, however, the display portion is released such that it may be pivoted relative to the base portion. In further embodiments, one or more springs bias the display portion towards the open direction such that the display portion automatically opens, at least partially, when the display portion is released.

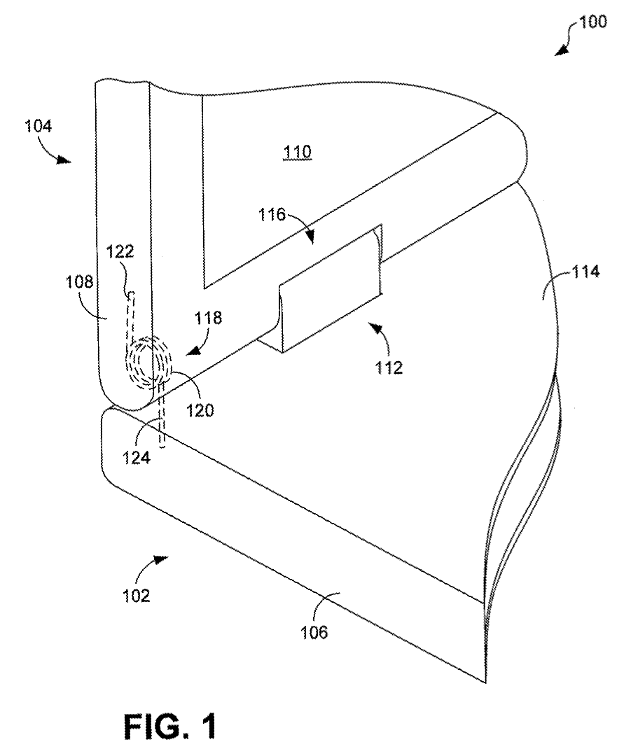

Referring now in more detail to the drawings in which like numerals indicate corresponding parts throughout the views, FIG. 1 illustrates, in partial view, a computing device 100 in the form of a notebook or “laptop” computer. More particularly, illustrated is a left corner of the computing device 100 formed by a distal left corner of a base portion 102 of the computing device and a bottom left corner of a display portion 104 of the computing device. The base portion 102 comprises an outer housing 106 that contains various internal components of the computing device 100, such as one or more processors, memory, and a hard disk. In addition, the housing 106 supports various user input devices, including a keyboard (not shown). The display portion 104 also comprises an outer housing 108, which supports a display 110.

The display portion 104 is pivotally connected to the base portion 102. As indicated in FIG. 1, a hinge 112 forms part of that pivotal connection. In the illustrated embodiment, the hinge 112 is mounted to the base portion 102 and extends upward from a top surface 114 of the base portion outer housing 106. The hinge 112 is received in a notch or gap 116 provided in the display portion outer housing 108. A pivot shaft (not shown) mounted within the display portion 104 extends through and is supported by the hinge 112 such that the shaft can pivot relative to the hinge and, therefore, the display portion can pivot relative to the base portion 102. In some embodiments, the hinge 112 comprises an internal friction mechanism (not shown) that resists free rotation of the pivot shaft to enable retention of the display portion 104 in desired orientations relative to the base portion 102.

With further reference to FIG. 1, the computing device 100 further includes at least one internal spring 118 that biases the display portion 104 toward an open direction. That is, the spring 118 is held in compression and therefore applies an opening force to the display portion 104. In the illustrated embodiment, the spring 118 comprises a torsion spring having a body 120 positioned within the display portion 104, for example aligned concentric with the pivot shaft, a first or upper tang 122 that extends outward from the body and within the display portion outer housing 108, and a second or lower tang 124 that extends outward from the body and into the base portion outer housing 106.

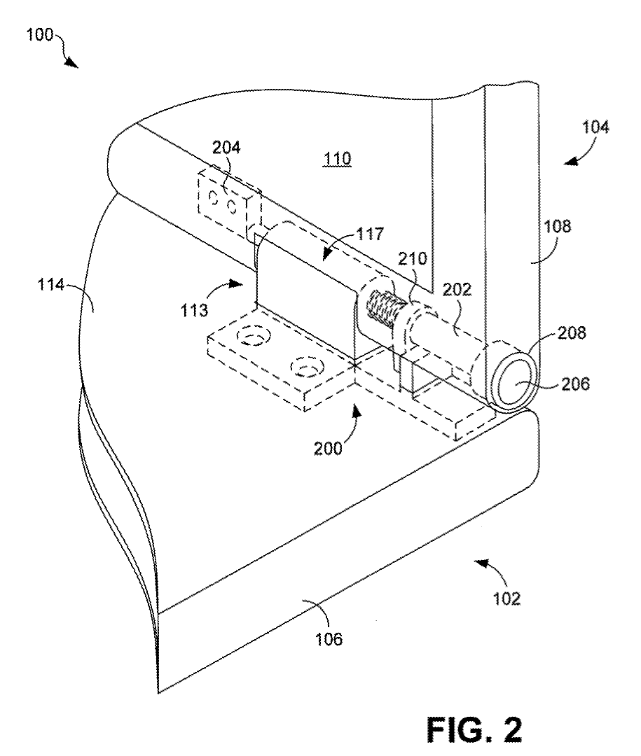

FIG. 2 illustrates, also in partial view, a right corner of the computing device 100 formed by a distal right corner of the base portion 102 and a bottom right corner of the display portion 104. As indicated in FIG. 2, the computing device 100 comprises a further hinge 113 that is mounted to the base portion 102 and received within a further notch or gap 117 of the display portion 104. Integrated with the hinge 113, however, is a locking mechanism 200 that is configured to lock the display portion 104 in the closed position. As is apparent from FIG. 2, the locking mechanism 200 is partly integrated with bath the base portion 102 and the display portion 104. The portion of the locking mechanism 200 integrated with the display portion 104 includes a pivot shaft 202 that extends through the hinge 113. Provided on a first or inner end of the pivot shaft 202 is a display mounting element 204 that is mounted to the display portion 104. As will be apparent from the disclosure that follows, the display mounting element 204 may linearly shift relative to the display member 104 in the longitudinal direction of the pivot shaft 202, but has a radial dimension extending from the pivot shaft that ensures that the display portion can only pivot when the display mounting element likewise pivots. Provided on a second or outer end of the pivot shaft 202 is a release button 206 that is accessible to the user through an opening 208 formed in the display portion outer housing 108. Between the display mounting element 204 and the release button 206 is a locking element 210 that is fixedly mounted to the pivot, shaft 202. When the locking mechanism 200 is in an initial locked position, the locking element 210 prevents pivoting of the pivot shaft 202 relative to the hinge 113, and therefore prevents pivoting of the display portion 104 relative to the base portion 102.

Although not illustrated in FIG. 2, the right corner of the computing device 100 can also include a spring similar to torsion spring 118 shown in FIG. 1. In such a case, a spring is provided on each side of the computing device 100 to assist in lifting or otherwise opening the display portion 104. In some embodiments, the additional spring is provided around the pivot shaft 202, for example between the release button 206 and the locking element 210.

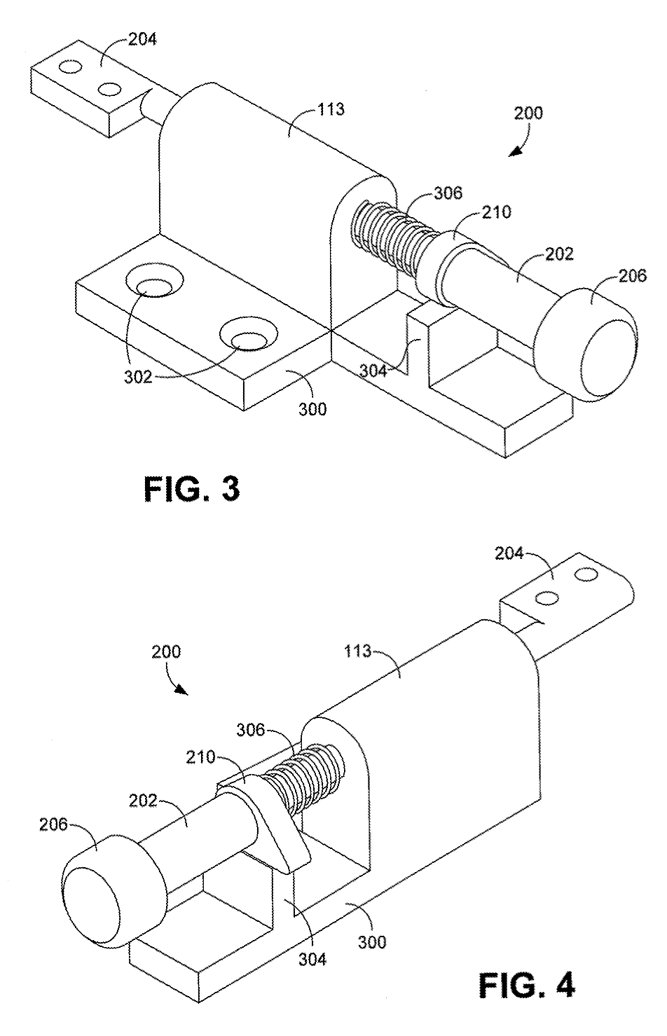

FIGS. 3 and 4 illustrate the locking mechanism 200 in the initial locked position. As indicated in those figures, the mechanism 200 includes a base 300 that supports the hinge 113 and that can be mounted within the base portion 102 of the computing device 100 using one or more mounting holes 302. Extending upward from the base 300 is a stop member 304 that the locking element 210 abuts in the locked position. The stop member 304 therefore can prevent pivoting of the pivot shaft 202, the display mounting element 204, and the display portion 104.

The locking element 210 is maintained in the position shown in FIGS. 3 and 4 by a compression spring 306 that, in the illustrated embodiment, is provided on the pivot shaft 202. The spring 306 biases the locking element 210 away from the hinge 113. That action likewise biases the release button 206 toward an extended position also shown in FIGS. 3 and 4. As described below, when the release button 206 is pressed inward against the force of the spring 306, the locking element 210 can clear the stop member 304 to enable the locking element, the pivot shaft 202, the display mounting element 204, and the display portion 104 to pivot. Such operation is described in relation to FIGS.

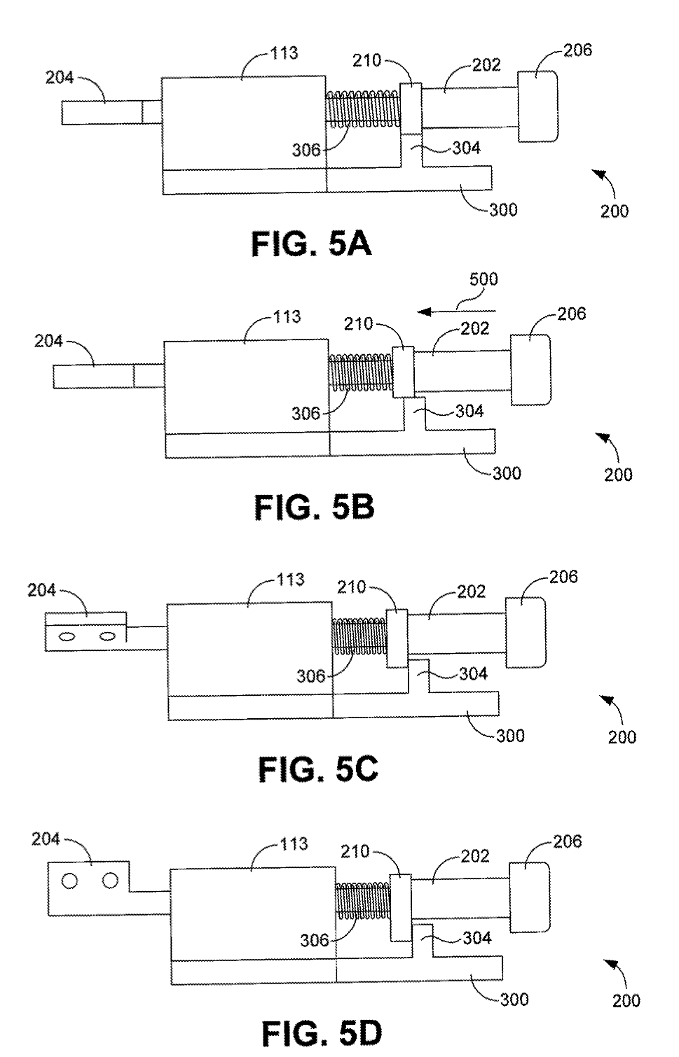

FIGS. 5A-5D illustrate transition of the locking mechanism 200 from an initial locked position to an open position in which pivoting of the display portion 104 is enabled. Beginning with FIG. 5A, the locking mechanism 200 is shown in the initial locked position first illustrated in FIGS. 3 and 4. As described above, the locking element 210, and therefore the pivot shaft 202 to which the locking element is fixedly mounted, cannot pivot in the locked position due to interference provided by the stop member 304, As further described above, however, such pivoting is possible when the locking element 210 is clear of the stop member 304. To that end, the release button 206 can be pressed inward (leftward in the orientation of FIGS. 5A-5D) as indicated in FIG. 5B by direction arrow 500. When the release button 206 is moved inward far enough, the locking element 210 will clear the stop member 304 as indicated in FIG. 5C so that the locking element, the pivot shaft 202, and the display mounting element 204 can pivot. Because the display mounting element 204 can pivot, the display portion 104 can be lifted or otherwise opened. In embodiments in which the computing device 100 includes one or more torsion springs, such as spring 118 shown in FIG. 1, such lifting or opening can be automatic. For example, the display portion 104 can automatically lift away from the base portion 102 to some limited degree (e.g., 10 to 30 degrees). In such a case, the locking mechanism 200 can also be described as an automatic opening mechanism. Furthermore, the torsion springs assist the user in opening the display portion farther.

Irrespective of whether the computing device 100 includes such torsion springs, the display portion 104 can be pivoted relative to the base portion 102 as desired once the locking mechanism 200 has been released. The position for the locking mechanism 200 in which the display portion 104 forms an angle of approximately 90 degrees with the base portion 102 (see FIG. 2) is illustrated in FIG. 5D. As is apparent from that figure, the display mounting element 204 is vertically aligned in that position, in contrast to the horizontal alignment shown in FIG. 5A associated with the locked position.

When the user wishes to close and again lock the computing device 100, the user can manually pivot the display portion 104 toward the base portion 102. When the display portion 104 is again in contact with or directly adjacent to the base portion 102, the locking element 210 can shift outwardly (to the right in the orientation of FIGS. 5A-5D) under the force of the spring 306 so as to place the locking mechanism back in the locked position shown in FIG. 5A.

1. A locking mechanism comprising:
a release button;
a pivot shaft on which the release button is provided;
a locking element fixedly mounted on the pivot shaft; and
a stop member that is aligned with the locking element when the locking mechanism is in a locked position;
wherein contact between the locking element and the stop member prevents pivoting of the locking element and the pivot shaft but depression of the release button moves the locking element clear of the stop member to enable pivoting of the pivot shaft.

2. The locking mechanism of claim 1, wherein the locking mechanism is adapted for integration into a computing device and wherein the release button is configured to be accessible to the user through an opening provided in a housing of the computing device.

3. The locking mechanism of claim 1, wherein the pivot shaft is configured to pass through a computing device hinge that pivotally mounts a display portion of the computing device to a base portion of the computing device.

4. The locking mechanism of claim 3, wherein the hinge comprises a friction hinge that retains the display portion in particular orientations relative to the base portion.

5. The locking mechanism of claim 1, further comprising a display mounting element provided on the pivot shaft, the display mounting element being configured to mount to a display portion of a computing device in a manner n which the display portion can only pivot when the display mounting element pivots.

6. The locking mechanism of claim 1, further comprising a compression spring that biases the locking element into a position in which the locking element aligns with the stop member.

7. The locking mechanism of claim 6, wherein the compression spring is provided on the pivot shaft.

8. A locking mechanism adapted for integration into a computing device having base portion and a display portion, the locking mechanism comprising:
a friction hinge;
a pivot shaft that extends through the friction hinge, the pivot shaft having a first end and a second end;
a display mounting element provided on the first end of the pivot shaft, the display mounting element being configured to mount to the display portion of the computing device in a manner in which the display portion can only pivot when the display mounting element pivots;
a locking element fixedly mounted to the pivot shaft;
a stop member that aligns with the locking element when the locking mechanism is in a locked position, wherein the stop member prevents pivoting of the locking element and the pivot shaft when the stop member is aligned with the locking element; and
a release button provided on the second end of the pivot shaft, wherein the release button can be pressed to move the locking element out of alignment with the stop member and enable pivoting of the locking element and the pivot shaft, wherein pivoting of the display mounting element and the display portion is enabled when pivoting of the pivot shaft is enabled.

9. The locking mechanism of claim 8, further comprising a compression spring that biases the locking element into a position in which the locking element aligns with the stop member.

10. The locking mechanism of claim 9, wherein the compression spring is provided on the pivot shaft.

11. A computing device, comprising:
a base portion;
a display portion;
a hinge that pivotally mounts the display portion to the base portion; and
a locking mechanism integrated with the hinge, the locking mechanism including a pivot shaft that extends through the hinge, the pivot shaft including a display mounting element mounted to the display portion in a manner in which the display portion can only pivot when the display mounting element pivots and a locking element that is fixedly mounted on the pivot shaft, the locking mechanism further including a stop member that is aligned with the locking element when the locking mechanism is in a locked position and a release button provided on the pivot shaft can be used to move the locking element clear of the stop member to enable pivoting of the pivot shaft.

12. The computing device of claim 11, wherein the hinge is mounted to the base portion and is received within a notch provided within the display portion.

13. The computing device of claim 12, wherein the display portion comprises an outer housing and wherein pivot hinge is contained within the outer housing.

14. The computing device of claim 13, wherein the outer housing includes an opening through which a user can access the release button.

15. The computing device of claim 11, wherein the hinge comprises a friction hinge that retains the display portion in particular orientations relative to the base portion.

16. The computing device of claim 11, wherein the locking mechanism further comprises a compression spring that biases the locking element into a position in which the locking element aligns with the stop member.

17. The computing device of claim 16, wherein the compression spring is provided on the pivot shaft.

18. The computing device of claim 11, further comprising a spring that biases the display portion toward an open direction.

19. The computing device of claim 18, wherein the spring comprises a torsion spring.

20. The computing device of claim 11, wherein the computing device comprises a notebook computer.
